(19) United States
(12) Patent Application Publication
(10) Pub. No.: US 2016/0293319 A1
(43) Pub. Date: Oct. 6, 2016

(54) COIL ELECTRONIC COMPONENT AND METHOD OF MANUFACTURING THE SAME

(71) Applicant: SAMSUNG ELECTRO-MECHANICS CO., LTD., Suwon-si (KR)

(72) Inventors: Yong Min HONG, Suwon-si (KR); Jong Ho LEE, Suwon-si (KR); Moon Soo PARK, Suwon-si (KR)

(21) Appl. No.: 15/002,140

(22) Filed: Jan. 20, 2016

(30) Foreign Application Priority Data
Apr. 1, 2015 (KR) 10-2015-0046165

(51) Int. Cl. H01F 27/28; H01F 41/00; H01F 1/06; H01F 41/04; H01F 27/255; H01F 41/02

(52) U.S. Cl. CPC H01F 27/2804; H01F 27/255; H01F 41/0246; H01F 1/06; H01F 41/041; H01F 41/005; H01F 2027/2809

(57) ABSTRACT

A coil electronic component includes a coil part, a magnetic body enclosing a core part formed in the coil part, and a ferrite oxide structure disposed in the core part.

### CROSS-REFERENCE TO RELATED APPLICATION

This application claims the benefit of priority to Korean Patent Application No. 10-2015-0046165, filed on Apr. 1, 2015 with the Korean Intellectual Property Office, the entirety of which is incorporated herein by reference.

### TECHNICAL FIELD

The present disclosure relates to a coil electronic component and a method of manufacturing the same.

### BACKGROUND

An inductor, a coil electronic component, is a representative passive element configuring an electronic circuit together with a resistor and a capacitor to remove noise therefrom.

An inductor may be manufactured by forming a coil part, hardening a magnetic powder-resin composite in which magnetic powder particles and a resin are mixed with each other to manufacture a magnetic body enclosing the coil part, and forming external electrodes on external surfaces of the magnetic body.

### SUMMARY

An aspect of the present disclosure provides a coil electronic component having a high inductance (L), and a method of manufacturing the same.

According to an aspect of the present disclosure, a coil electronic component includes: a coil part; a magnetic body enclosing a core part formed in the coil part; and a ferrite oxide structure inserted into the core part.

The ferrite oxide structure may be a sintered ferrite oxide structure.

A direction of magnetic permeability of the ferrite oxide structure may coincide with a direction in which magnetic flux flows.

The coil electronic component may further comprise ferrite oxide structures disposed in outer peripheral portions formed at outer sides of the coil part.

A direction of magnetic permeability of the ferrite oxide structures disposed in the outer peripheral portions formed at the outer sides of the coil part may coincide with a direction in which magnetic flux flows.

The magnetic body may contain metal powder particles of one or more selected from the group consisting of iron (Fe), silicon (Si), boron (B), chrome (Cr), aluminum (Al), copper (Cu), niobium (Nb), and nickel (Ni).

Coil patterns of the coil part have a form of planar coils formed on the same plane.

The metal powder particles may comprise isotropic metal powder particles.

At least one of upper and lower regions of the coil electronic component may contain the isotropic metal powder particles.

According to another aspect of the present disclosure, a method of manufacturing a coil electronic component includes: forming a coil part including a core part formed therein; inserting a ferrite oxide structure into the core part; and enclosing the coil part with a magnetic body containing powder particles.

### BRIEF DESCRIPTION OF THE DRAWINGS

The above and other aspects, features and other advantages of the present disclosure will be more clearly understood from the following detailed description taken in conjunction with the accompanying drawings.

FIG. 1 is a perspective view illustrating a coil electronic component according to an exemplary embodiment in the present disclosure so that a coil part of the coil electronic component is visible.

FIG. 2 is a cross-sectional view taken along line I-I′ of FIG. 1.

FIG. 3 is a perspective view illustrating a coil electronic component according to another exemplary embodiment in the present disclosure so that a coil part of the coil electronic component is visible.

FIG. 4 is a cross-sectional view taken along line II-II′ of FIG. 3.

FIGS. 5A through 5C are views sequentially illustrating a method of manufacturing a coil electronic component according to another exemplary embodiment in the present disclosure.

### DETAILED DESCRIPTION

Hereinafter, embodiments of the present inventive concept will be described as follows with reference to the attached drawings.

The present inventive concept may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “upper,” or “above” other elements would then be oriented “lower,” or “below” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the present inventive concept. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present inventive concept will be described with reference to schematic views illustrating embodiments of the present inventive concept. In the drawings, for example, due to manufacturing techniques and/or tolerances, modifications of the shape shown may be estimated. Thus, embodiments of the present inventive concept should not be construed as being limited to the particular shapes of regions shown herein, for example, to include a change in shape results in manufacturing. The following embodiments may also be constituted by one or a combination thereof.

The contents of the present inventive concept described below may have a variety of configurations and propose only a required configuration herein, but are not limited thereto.

### Coil Electronic Component

Hereinafter, a coil electronic component according to an exemplary embodiment in the present disclosure, particularly, a thin film type inductor, will be described. However, the coil electronic component according to an exemplary embodiment in the present disclosure is not limited thereto.

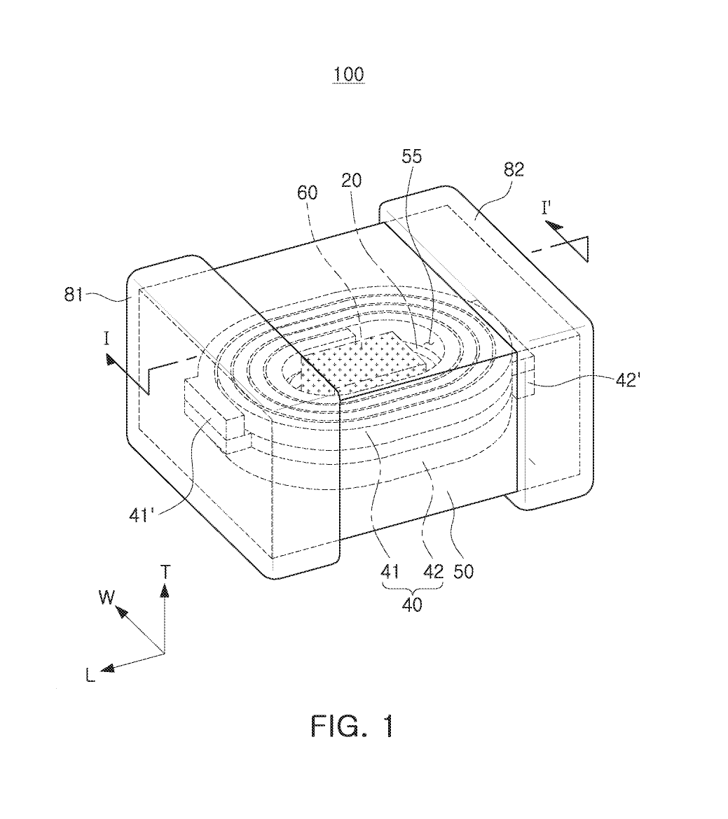

FIG. 1 is a perspective view illustrating a coil electronic component according to an exemplary embodiment in the present disclosure so that a coil part of the coil electronic component is visible.

Referring to FIG. 1, a thin film type power inductor used in a power line of a power supplying circuit is disclosed as an example of the coil electronic component.

A coil electronic component 100 according to an exemplary embodiment in the present disclosure may include a coil part 40, a magnetic body 50 enclosing a core part 55 formed in the coil part 40, and first and second external electrodes 81 and 82 disposed on external surfaces of the magnetic body 50 and contacting the coil part 40.

In the coil electronic component 100 according to an exemplary embodiment in the present disclosure, a ‘length’ direction refers to an ‘L’ direction of FIG. 1, a ‘width’ direction refers to a ‘W’ direction of FIG. 1, and a ‘thickness’ direction refers to a ‘T’ direction of FIG. 1.

The coil part 40 may be formed by connecting a first coil conductor 41 formed on a first surface of a substrate 20 and a second coil conductor 42 formed on a second surface of the substrate 20 opposing the first surface of the substrate 20 to each other.

Each of the first and second coil conductors 41 and 42 may have a form of planar coils formed on the same plane of the substrate 20.

The first and second coil conductors 41 and 42 may have a spiral shape.

The first and second coil conductors 41 and 42 may be formed on the substrate 20 through electroplating, but are not limited thereto.

In addition, the first and second coil conductors 41 and 42 may be formed on the first and second surfaces of the substrate 20, respectively, but are not limited thereto. That is, the first and second coil conductors 41 and 42 may have a single layer form or a multilayer form.

The first and second coil conductors 41 and 42 may be formed of a metal having excellent electrical conductivity, for example, silver (Ag), palladium (Pd), aluminum (Al), nickel (Ni), titanium (Ti), gold (Au), copper (Cu), platinum (Pt), or alloys thereof.

The first and second coil conductors 41 and 42 may be coated with an insulating layer (not illustrated), such that they may not be in direct contact with a magnetic material forming the magnetic body 50.

The substrate 20 may be, for example, a polypropylene glycol (PPG) substrate, a ferrite substrate, a metal based soft magnetic substrate, or the like.

The substrate 20 may have a through-hole formed by removing a central portion thereof, wherein the through-hole may be filled with a magnetic material to form the core part 55 in the coil part 40.

Since the core part 55 is filled with the magnetic material, an area of the magnetic body through which magnetic flux passes may be increased to improve inductance (L).

However, the substrate 20 is not necessarily included, and the coil part may also be formed of a metal wire without the substrate.

The magnetic body 50 enclosing the coil part 40 may contain any magnetic material exhibiting magnetic properties, for example, ferrite or metal magnetic powder particles.

The higher the magnetic permeability of the magnetic material contained in the magnetic body 50, and the larger the area of the magnetic body 50 through which the magnetic flux passes, the higher the inductance (L) of the inductor 100.

One end portion of the first coil conductor 41 may be extended to form a first lead portion 41′, exposed to a first end surface of the magnetic body 50 in the length L direction, and one end portion of the second coil conductor 42 may be extended to form a second lead portion 42′ exposed to a second end surface of the magnetic body 50 in the length L direction opposing the first end surface of the magnetic body 50.

However, the first and second lead portions 41′ and 42′ are not necessarily limited to being exposed as described above, but may be exposed to at least one surface of the magnetic body 50.

The first and second external electrodes 81 and 82 may be formed on the external surfaces of the magnetic body 50 to be connected, respectively, to the first and second lead portions 41′ and 42′ exposed to the first and second end surfaces of the magnetic body 50.

The first and second external electrodes 81 and 82 may be formed of a metal having excellent electrical conductivity, for example, copper (Cu), silver (Ag), nickel (Ni), tin (Sn), or the like, or alloys thereof.

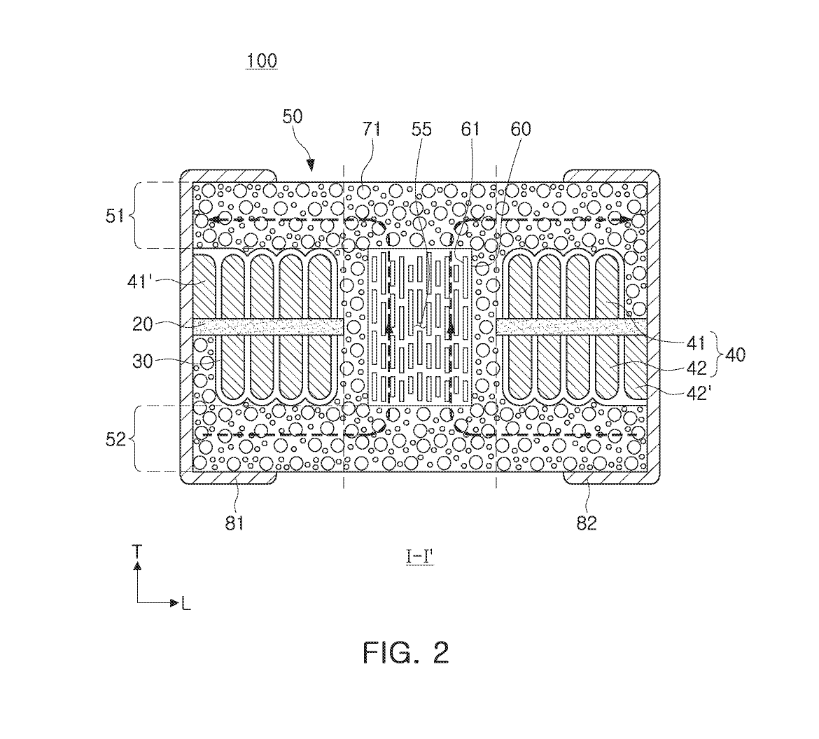

FIG. 2 is a cross-sectional view taken along line I-I′ of FIG. 1.

Referring to FIG. 2, showing the coil electronic component 100 according to an exemplary embodiment in the present disclosure, a ferrite oxide structure 60 may be inserted into the core part 55.

Generally, in a case of manufacturing a thin film type inductor, magnetic sheets containing ferrite or metal powder particles may be stacked, compressed, and hardened on and beneath a coil part having a core part by forming a coil pattern on at least one surface of a substrate having a through-hole formed in a central portion thereof, thereby forming a magnetic body enclosing the coil part.

A magnetic material may also be filled in the core part at the time of stacking and compressing the magnetic sheets containing the ferrite or metal powder particles on and beneath the coil part, such that an area of the magnetic body through which magnetic flux passes is increased, thereby improving inductance (L).

However, in a case of filling the magnetic material in the core part by stacking and compressing the magnetic sheets as described above, a packing factor of the magnetic material in the core part is not high, such that there is no inductance improvement effect.

In order to solve this problem, the magnetic sheet may contain spherical metal powder particles to increase the packing factor of the core part, thereby improving magnetic permeability. However, in such a case, magnetic permeability of the material itself may be low.

According to an exemplary embodiment in the present disclosure, the ferrite oxide structure 60 having high magnetic permeability may be inserted into the core part 55 to significantly increase the packing factor and magnetic permeability, thereby improving the inductance.

The ferrite oxide structure 60 may be formed by sintering, for example, ferrite oxides 61, but is not limited thereto.

That is, the ferrite oxide structure 60 may be manufactured by cutting a sintered ferrite oxide bar by a dicing method, and the coil electronic component may be implemented by inserting the ferrite oxide structure 60 into the core part 55 and stacking the magnetic sheets.

A shape of the ferrite oxide structure 60 is not particularly limited, but may be, for example, a hexahedral shape, as illustrated in FIG. 1.

A direction of magnetic permeability of the ferrite oxide structure 60 may coincide with a direction in which magnetic flux flows.

That is, the sintered ferrite oxide structure 60 may have high magnetic permeability of about 20 to 1000, and may not have shape anisotropy. Therefore, a coil electronic component having high magnetic permeability may be implemented by allowing the direction in which the magnetic flux flows and the direction of the magnetic permeability of the ferrite oxide structure 60 to coincide with each other.

Referring to FIG. 2, the ferrite oxide structure 60 may occupy most of a central region of the core part 55 in a cross section of the coil electronic component in the length direction, and a partial region of the central portion may be filled with a magnetic material containing metal powder particles by the stacking and compressing of the magnetic sheets.

Alternatively, the ferrite oxide structure 60 may also be filled in an entire region of the core part 55 in the cross section of the coil electronic component in the length direction.

Referring to FIG. 2, the magnetic body 50 of the coil electronic component 100 according to an exemplary embodiment in the present disclosure may contain metal magnetic powder particles having a form of isotropic metal powder particles 71, but is not limited thereto. For example, the magnetic body 50 may also contain metal magnetic powder particles having the form of anisotropic metal powder particles.

The isotropic metal powder 71 may be formed of a metal containing one or more selected from the group consisting of iron (Fe), silicon (Si), boron (B), chrome (Cr), aluminum (Al), copper (Cu), niobium (Nb), and nickel (Ni), or alloys thereof, and may be formed of a crystalline or amorphous metal.

For example, the isotropic metal powder 71 may be a Fe—Si—Cr based amorphous metal, but is not limited thereto.

The metal magnetic powder particles having the form of the isotropic metal powder particles 71 may be contained in the magnetic body 50 in a form in which they are dispersed in a thermosetting resin.

The thermosetting resin may be, for example, an epoxy resin, a polyimide resin, or the like.

The isotropic metal powder 71 may have a spherical shape. Shape isotropy means that the same magnetic properties are exhibited in the x, y, and z axis directions.

The isotropic metal powder particles 71 may show the same magnetic permeability in the x, y, and z axis directions.

In an exemplary embodiment in the present disclosure, in a case in which the magnetic body 50 contains the metal magnetic powder particles having the form of the anisotropic metal powder particles rather than the form of the isotropic metal powder particles 71, one axis of a flake-shaped surface of the anisotropic metal powder particles may be arranged in the direction in which the magnetic flux flows, thereby smoothing the flow of the magnetic flux and improving inductance (L) through high magnetic permeability.

That is, according to an exemplary embodiment in the present disclosure, the metal magnetic powder particles having the form of the isotropic metal powder particles 71 may be contained in the entirety of first and second cover parts 51 and 52, but are not limited thereto. For example, the metal magnetic powder particles having the form of the anisotropic metal powder particles may also be contained in the first and second cover parts 51 and 52.

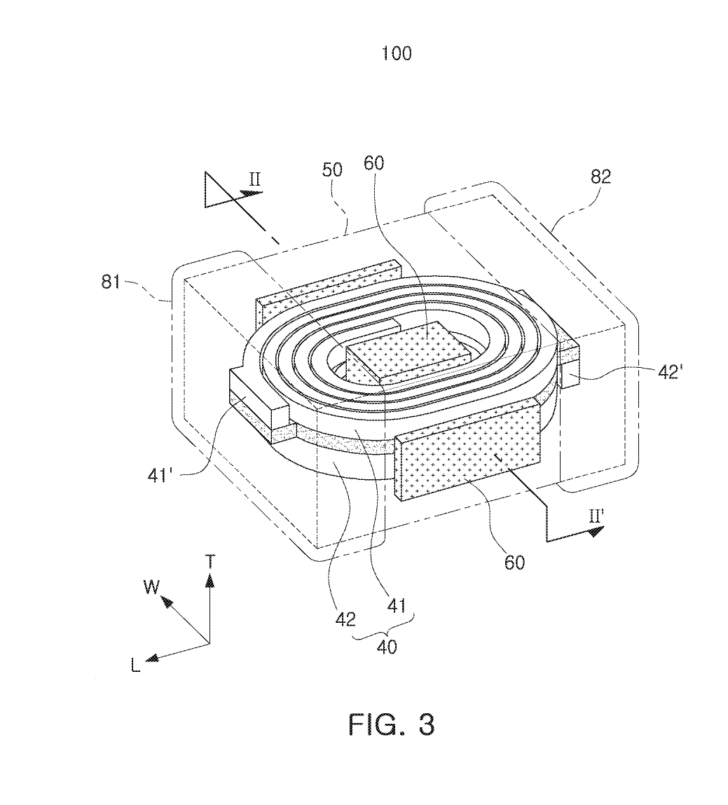

FIG. 3 is a perspective view illustrating a coil electronic component according to another exemplary embodiment in the present disclosure so that a coil part of the coil electronic component is visible.

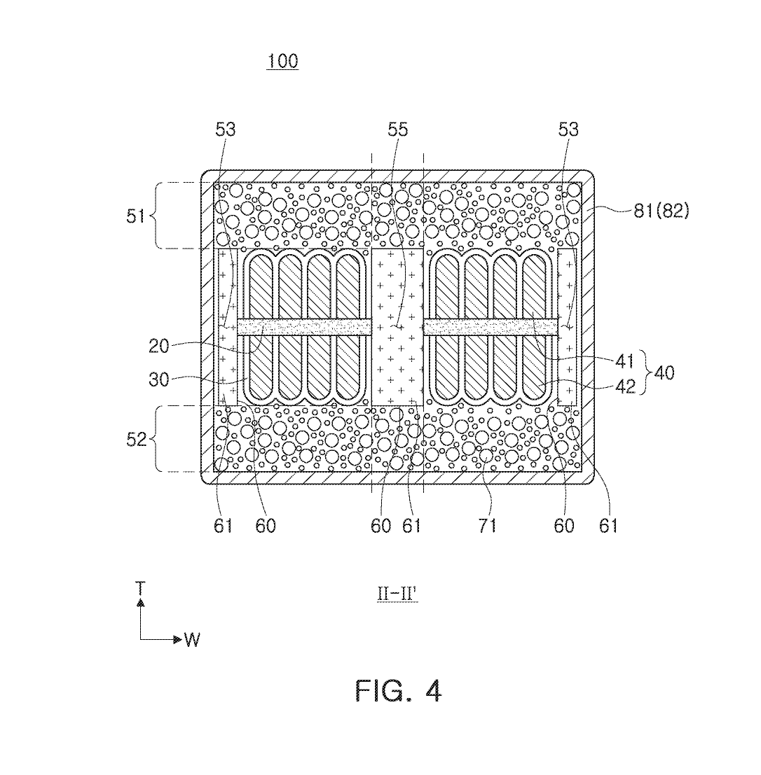

FIG. 4 is a cross-sectional view taken along line II-II′ of FIG. 3.

Referring to FIGS. 3 and 4, a coil electronic component 100 according to another exemplary embodiment in the present disclosure may include a ferrite oxide structure 60 disposed in the core part 55 formed in the coil part 40 and further include ferrite oxide structures 60 disposed in outer peripheral portions 53 formed at outer sides of the coil part 40.

A direction of magnetic permeability of the ferrite oxide structures 60 formed in the outer peripheral portions 53 may coincide with a direction in which magnetic flux flows, similar to that of the ferrite oxide structure 60 disposed in the core part 55.

Although a case in which the coil electronic component 100 further includes the ferrite oxide structures 60 disposed in both of the outer peripheral portions 53 formed at both outer sides of the coil part 40 has been illustrated in FIGS. 3 and 4, the coil electronic component 100 is not limited thereto, but may also include the ferrite oxide structure 60 disposed in at least one of the outer peripheral portions 53 formed at both outer sides of the coil part 40.

The ferrite oxide structures 60 inserted into the outer peripheral portions 53 formed at both outer sides of the coil part 40 may be filled in the entire outer peripheral portions 53. Alternatively, the ferrite oxide structures 60 inserted into the outer peripheral portions 53 formed at both outer sides of the coil part 40 may be filled in only partial regions of the outer peripheral portions 53, and the remaining regions may be filled with a magnetic material containing metal powder particles by the stacking and the compressing of the magnetic sheets.

The coil electronic component 100 according to another exemplary embodiment in the present disclosure may include the ferrite oxide structure 60 inserted into the core part 55 formed in the coil part 40 and may further include the ferrite oxide structures 60 inserted into the outer peripheral portions 53 formed at the outer sides of the coil part 40, such that a direction in which magnetic flux flows and a direction of magnetic permeability of a material having high magnetic permeability coincide with each other, whereby inductance of the coil electronic component may be improved.

The coil electronic component 100 according to another exemplary embodiment in the present disclosure illustrated in FIGS. 3 and 4 may have the same configuration as that of the coil electronic component 100 according to the exemplary embodiment in the present disclosure described above except that it further includes the ferrite oxide structures 60 inserted into the outer peripheral portions 53 formed at the outer sides of the coil part 40.

### Method of Manufacturing Coil Electronic Component

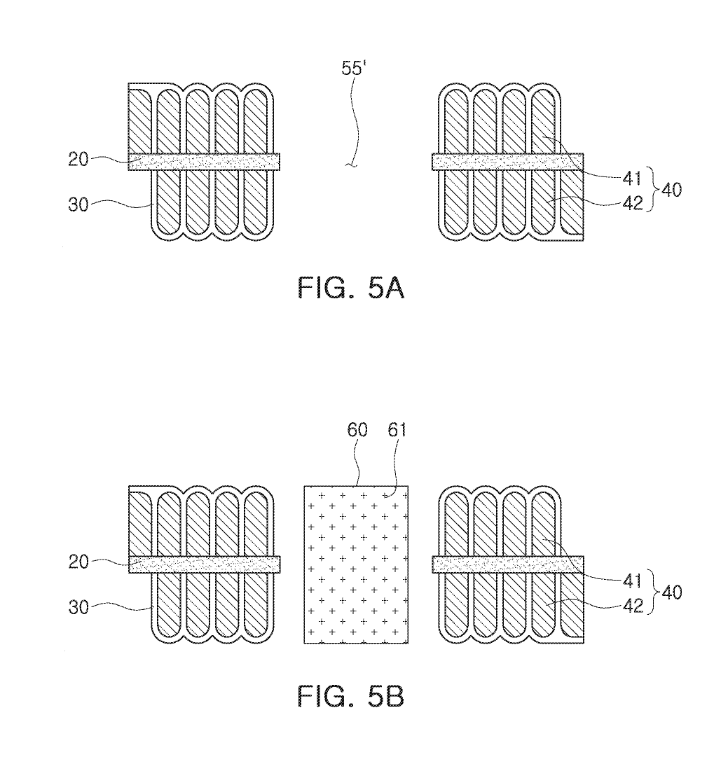

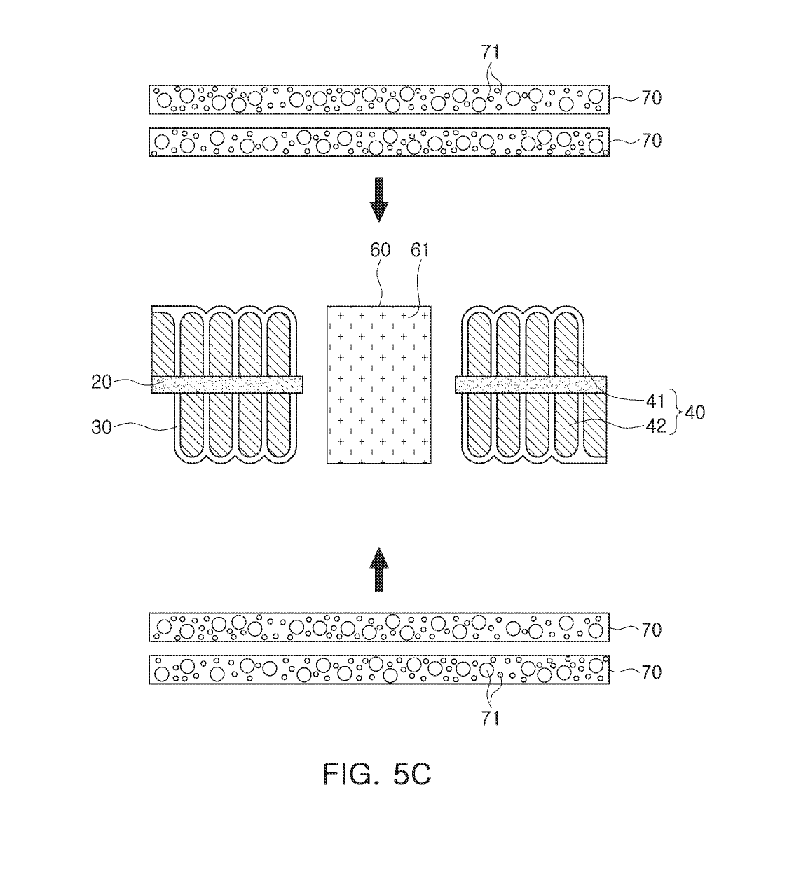

FIGS. 5A through 5C are views sequentially illustrating a method of manufacturing a coil electronic component according to another exemplary embodiment in the present disclosure.

A method of manufacturing a coil electronic component according to anther exemplary embodiment in the present disclosure may include forming the coil part including the core part formed therein; inserting the ferrite oxide structure into the core part; and enclosing the coil part with the magnetic body containing the metal powder particles.

Referring to FIG. 5A, the coil part 40 may first be formed.

A via hole (not illustrated) may be formed in the substrate 20, a plating resist (not illustrated) having an opening may be formed on the substrate 20, the via hole and the opening may be filled with a conductive metal by plating to form the first and second coil conductors 41 and 42 and a via (not illustrated) connecting the first and second coil conductors 41 and 42 to each other.

The first and second coil conductors 41 and 42 and the via may be formed of a conductive metal having excellent electrical conductivity, for example, silver (Ag), palladium (Pd), aluminum (Al), nickel (Ni), titanium (Ti), gold (Au), copper (Cu), platinum (Pt), or alloys thereof.

However, a method of forming the coil part 40 is not necessarily limited to the above-mentioned plating. For example, the coil part 40 may be formed of a metal wire or be formed of any material that may generate magnetic flux by a current applied thereto.

An insulating layer 30 covering the first and second coil conductors 41 and 42 may be formed on the first and second coil conductors 41 and 42.

The insulating layer 30 may contain a polymer material such as an epoxy resin, a polyimide resin, or the like, a photo-resist (PR), a metal oxide, and the like. However, a material of the insulating layer 30 is not limited thereto, but may be any insulating material that may enclose the first and second coil conductors 41 and 42 to prevent a short-circuit.

The insulating layer 30 may be formed by a method such as a screen printing method, a photo-resist (PR) exposure and development method, a spray application method, an oxidation method through chemical etching of the coil conductors, or the like.

A core part hole 55′ maybe formed by removing a central portion of the substrate 20 on which the first and second coil conductors 41 and 42 are not formed.

The central portion of the substrate 20 may be removed by mechanical drilling, laser drilling, sand blasting, punching, or the like.

Referring to FIG. 5B, the ferrite oxide structure 60 may be inserted into the core part hole 55′ corresponding to the core part formed in the coil part 40.

The ferrite oxide structure 60 may be manufactured by cutting a sintered ferrite oxide bar using a dicing method.

That is, the ferrite oxide structure 60 may be formed by cutting the ferrite oxide bar formed by sintering the ferrite oxide 61.

Referring to FIG. 5C, sheets 70 containing the metal magnetic powder particles having the isotropic metal powder particles 71 may be stacked, compressed, and hardened on and beneath the coil part 40 to form the magnetic body 50 enclosing the coil part 40.

The sheets 70 may be manufactured in a sheet shape by mixing the isotropic metal powder particles 71, a thermosetting resin, and organic materials such as a binder, a solvent, and the like, with each other to prepare slurry and applying and then drying the slurry at a thickness of several ten micrometers on carrier films by a doctor blade method.

The sheet 70 may be manufactured in a form in which the isotropic metal powder particles 71 are dispersed in a thermosetting resin such as an epoxy resin, a polyimide resin, or the like.

The sheets 70 containing the isotropic metal powder particles 71 may be stacked, compressed, and hardened on and beneath the coil part 40 to fill portions other than the core part into which the ferrite oxide structure 60 is inserted with the isotropic metal powder particles 71.

That is, when the sheets 70 containing the isotropic metal powder particles 71 are stacked and compressed on and beneath the coil part 40, the first and second cover parts 51 and 52, upper and lower regions of the core part 55, maybe filled with the isotropic metal powder particles 71.

Next, the first and second external electrodes 81 and 82 may be formed on the external surfaces of the magnetic body 50 to be connected to the coil part 40.

Descriptions of features overlapped with those of the coil electronic component according to the exemplary embodiment in the present disclosure described above except for the above-mentioned description will be omitted.

As set forth above, according to exemplary embodiments in the present disclosure, the ferrite oxide structure having the high magnetic permeability may be inserted into the core part, whereby the coil electronic component having a high inductance may be implemented.

While exemplary embodiments have been shown and described above, it will be apparent to those skilled in the art that modifications and variations could be made without departing from the scope of the present invention as defined by the appended claims.

What is claimed is:

1. A coil electronic component comprising:
a coil part;
a magnetic body enclosing a core part formed in the coil part; and
a ferrite oxide structure disposed in the core part.

2. The coil electronic component of claim 1, wherein the ferrite oxide structure is a sintered ferrite oxide structure.

3. The coil electronic component of claim 1, wherein a direction of magnetic permeability of the ferrite oxide structure coincides with a direction in which magnetic flux flows.

4. The coil electronic component of claim 1, further comprising ferrite oxide structures disposed in outer peripheral portions formed at outer sides of the coil part.

5. The coil electronic component of claim 4, wherein a direction of magnetic permeability of the ferrite oxide structures disposed in the outer peripheral portions formed at the outer sides of the coil part coincides with a direction in which magnetic flux flows.

6. The coil electronic component of claim 1, wherein the magnetic body contains metal powder particles of one or more selected from the group consisting of iron (Fe), silicon (Si), boron (B), chrome (Cr), aluminum (Al), copper (Cu), niobium (Nb), and nickel (Ni).

7. The coil electronic component of claim 1, wherein coil patterns of the coil part have a form of planar coils formed on the same plane.

8. The coil electronic component of claim 6, wherein the metal powder particles comprise isotropic metal powder particles.

9. The coil electronic component of claim 8, wherein at least one of upper and lower regions of the coil electronic component contain the isotropic metal powder particles.

10. A method of manufacturing a coil electronic component, comprising steps of:
forming a coil part including a core part formed therein;
inserting a ferrite oxide structure into the core part; and
enclosing the coil part with a magnetic body containing metal powder particles.

11. The method of claim 10, wherein the ferrite oxide structure is a sintered ferrite oxide structure.

12. The method of claim 10, wherein a direction of magnetic permeability of the ferrite oxide structure coincides with a direction in which magnetic flux flows.

13. The method of claim 10, further comprising inserting ferrite oxide structures into outer peripheral portions formed at outer sides of the coil part.

14. The method of claim 13, wherein a direction of magnetic permeability of the ferrite oxide structures disposed in the outer peripheral portions formed at the outer sides of the coil part coincides with a direction in which magnetic flux flows.

15. The method of claim 10, wherein the metal powder is one or more selected from the group consisting of iron (Fe), silicon (Si), boron (B), chrome (Cr), aluminum (Al), copper (Cu), niobium (Nb), and nickel (Ni).

16. The method of claim 10, wherein coil patterns of the coil part have a form of planar coils formed on the same plane.

17. The method of claim 10, wherein the metal powder particles comprise isotropic metal powder particles.
